(19) United States
(12) Patent Application Publication
(10) Pub. No.: US 2007/0259434 A1
(43) Pub. Date: Nov. 8, 2007

(54) Rapid method for determining radiochemical purity of in-111-pentetreotide

(75) Inventors: Chien-Chung Hsia, Daxi Town (TW); Lie-Hang Shen, Jhongli City (TW)

Correspondence Address: TROXELL LAW OFFICE PLLC, SUITE 1404, 5205 LEESBURG PIKE, FALLS CHURCH, VA, 22041, US

(73) Assignee: Atomic energy Council-Institute of Nuclear Energy Research, Taoyuan (TW)

(21) Appl. No.: 11/418,018

(22) Filed: May 5, 2006

(51) Int. Cl. G01N 23/00

(52) U.S. Cl. 436/57; 436/161

(57) ABSTRACT

An analysis over a radiochemical material is done by using a thin layer chromatography. Consequently, a radiochemical purity of a sample is figured out in a short time through a easy steps.

### FIELD OF THE INVENTION

The present invention relates to an analytic method; more particularly, relates to easily and quickly obtaining an analysis on the radiochemical purity (RCP) of a sample.

### DESCRIPTION OF THE RELATED ARTS

Usually, a method used to obtain an analysis of RCP is selected from the following methods: one is an analysis method by using a Sep-Pac cartridge, and the other is an analysis method by using a High Pressure Liquid Chromatography (HPLC) system.

Regarding the analytic method by using a Sep-Pac cartridge, Sep-Pac cartridges (Waters, Milford, Mass., USA) are at first washed with methanol and water for injection; a plastic piston syringe having 1 milliliter (ml) capacity is used to aspirate 0.1 ml of a reconstruction sample of In-111-Pentetreotide to be injected into a Sep-Pac cartridge with 5 mL of water for injection added into the same cartridge while a first glass vial is used to collect the first fluid overflowed. Then, another piston syringe aspirates 5 mL of methanol is followed to flow through the same cartridge using the same way mentioned just now while a second glass vial is used to collect the second fluid overflowed. In the end, the other piston syringe aspirates 10 ml of air to be separately injected into the cartridges while a third glass vial is used to collect the third fluid overflowed; and then a radioactivity measurement (Capintac CRC-15 R ) i s used to measure radio-activities of the first, the second and the third glass vial to obtain the results A, B, C, respectively. So that the RCP for the sample of In-111-Pentetreotide is obtained according to the following formula:
[B/(A+B+C)]×100%.

Regarding the analysis method by using the HPLC system, a sodium acetate solution (solution A) and a methanol (solution B) are prepared. The solution A is obtained through the following steps: obtaining 6.8 g of sodium acetate accurately weighted; solving the sodium acetate into 500 mL of water for injection; adjusting the pH value of the solution to 5.5 by adding glacial acetic acid; and diluting the solution with water to 1000 ml amount. Then, a stainless steel tube filled with 10-μm C18 (VERCOPACK, 4.0 mm×30 cm) is used as a separation column. An irrigation solution is set to function in a gradient way, where ‘60% of solution A together with 40% of solution B’ is linearly changed to ‘20% of solution A together with 80% of solution B’ under a flow rate of 1 mL/min. A change monitor over radioactivity is done with a radio-detector to be shown by a diagram drawn. In the end, the RCP of In-111-Pentetreotide is obtained by an area integration of the diagram.

Although the above prior arts both can analyze the RCP of In-111-Pentetreotide, the equipments and the procedure used are complex with long processing time. Hence, the prior arts do not fulfill users' requests on actual use.

### SUMMARY OF THE INVENTION

The present invention is to easily and quickly obtain an analysis on an RCP of a sample.

To achieve the above purpose, the present invention is a rapid method for determining an RCP of In-111-Pentetreotide, where an analysis of an RCP is obtained by using a technology of Thin-Layer Chromatography; the rapid method comprises steps of labeling developing spots, dropping a sample, developing the sample, heating and drying on the hotplate and obtaining the chromatogram for an analysis. At first, an Instant Thin-Layer Chromatography-Silica Gel (ITLC-SG) is obtained to be labeled with a beginning spot and an ending spot upon; then a sample of a reconstruction of the radioactive material is dropped at the beginning spot of the ITLC-SG. Later, the ITLC-SG is deposed in a developing tank to develop the sample and the developing tank has a buffer solution at bottom of the developing tank; after a liquid surface of the sample is developed to arrive at the ending spot of the ITLC-SG, the ITLC-SG is taken out to be dried by heating on the hot plate. Finally, after the ITLC-SG is dried by heating, the ITLC-SG is taken out to be analyzed by a radio-thin-layer chromatography scanner through an integration chromatography. Accordingly, a novel rapid method for determining an RCP of In-111-Pentetreotide is obtained.

### BRIEF DESCRIPTIONS OF THE DRAWINGS

The present invention will be better understood from the following detailed description of the preferred embodiment according to the present invention, taken in conjunction with the accompanying drawings, in which

FIG. 1 is a view showing a flow chart of the preferred embodiment according to the present invention;

FIG. 2, FIG. 3 and FIG. 4 are views showing the preferred embodiment on labeling the developing spots, dropping the sample and developing the sample; and

FIG. 5 is a view showing the analysis results of RCP by using the present invention and the prior arts.

### DESCRIPTION OF THE PREFERRED EMBODIMENT

The following description of the preferred embodiment is provided to understand the features and the structures of the present invention.

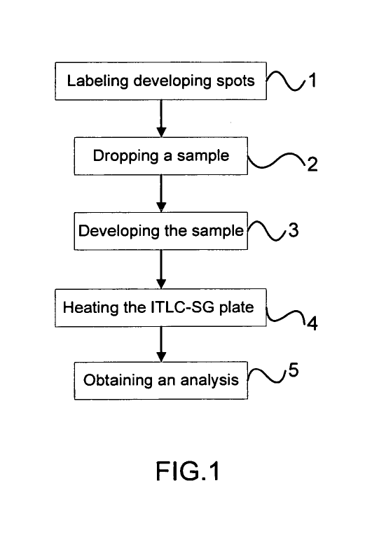

Please refer to FIG. 1, which is a view showing a flowchart of the preferred embodiment according to the present invention. As shown in the figure, the present invention is a rapid method for determining radiochemical purity (RCP) of In-111-Pentetreotide, comprising steps of labeling developing spots [1], dropping a sample [2], developing the sample [3], Heating the ITLC-SG plate [4] and obtaining an chromatogram for analysis [5], where an analysis of RCP of a sample is easily and quickly obtained.

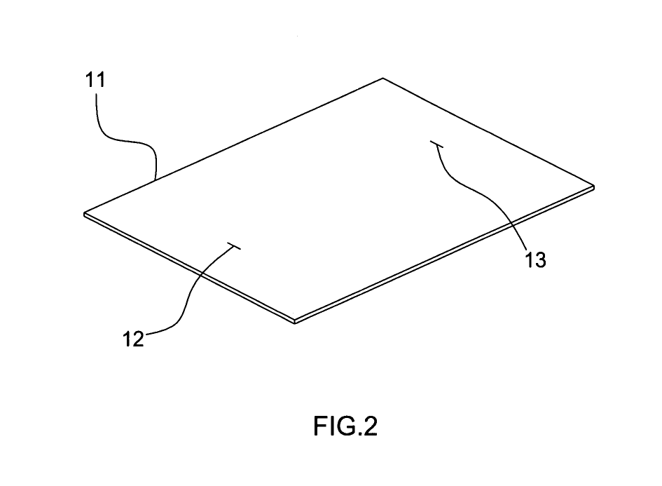

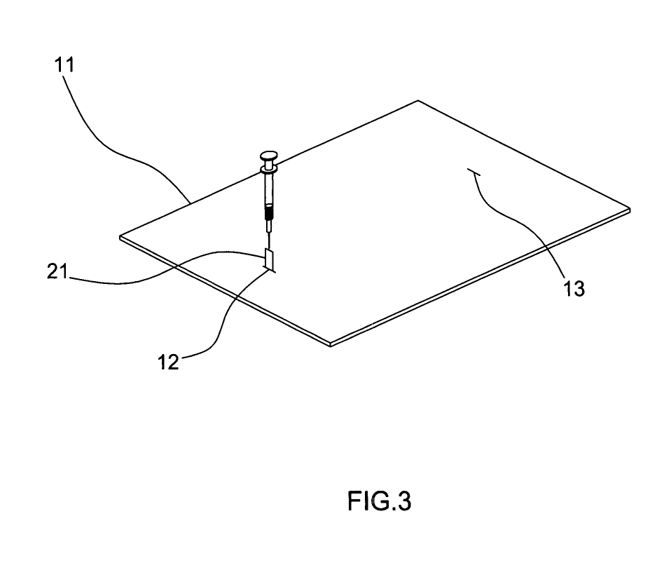

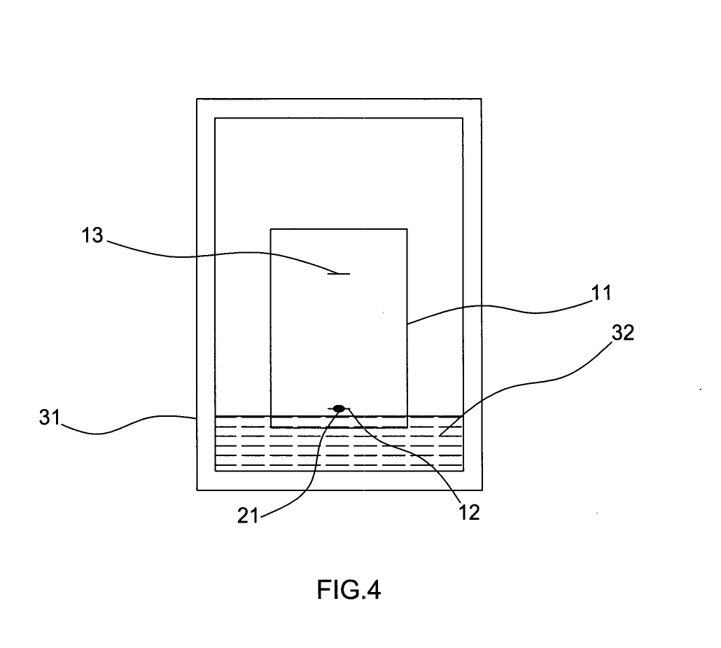

Please refer to FIG. 2, FIG. 3 and FIG. 4, which are views showing the preferred embodiment on labeling the developing spots, dropping the sample and developing the sample. As shown in the figures, when the present invention analyzes an RCP, the analysis method comprises the following steps:

(A) Labeling developing spots: At first, a plate of an Instant Thin-Layer Chromatography-Silica Gel (ITLC-SG) [11] is obtained to be labeled with a beginning spot [12] at 2 centimeters (cm) to a boarder of the ITLC-SG [11] and an ending spot [13] at 12 cm to the boarder of the ITLC-SG [11].

(B ) Dropping a sample: Then, a sample [21] of a reconstruction of a radioactive material is dropped at the beginning spot [12] of the ITLC-SG

(C) Developing the sample: The ITLC-SG [11] dropped with the sample [21] is put in a developing tank [31] having a buffer solution of citrate buffer [32] at bottom to develop the sample; and the citrate buffer [32] of the developing tank [31] has a liquid level at 0.5 cm.

(D) Heating a plate: After a liquid surface of the sample [21] is developed to arrive at the ending spot [13] of the ITLC-SG [11], the ITLC-SG [11] is taken out to be dried by heating in a fume hood.

(E) Obtaining an analysis: Finally, after the ITLC-SG [11] is dried in step (D) of “Heating the ITLC-SG plate [4]”, the ITLC-SG [11] is taken out to be analyzed by a radio-thin-layer chromatography scanner (Bioscan-2000) through an integration chromatography so that an analysis of an RCP of the sample is obtained.

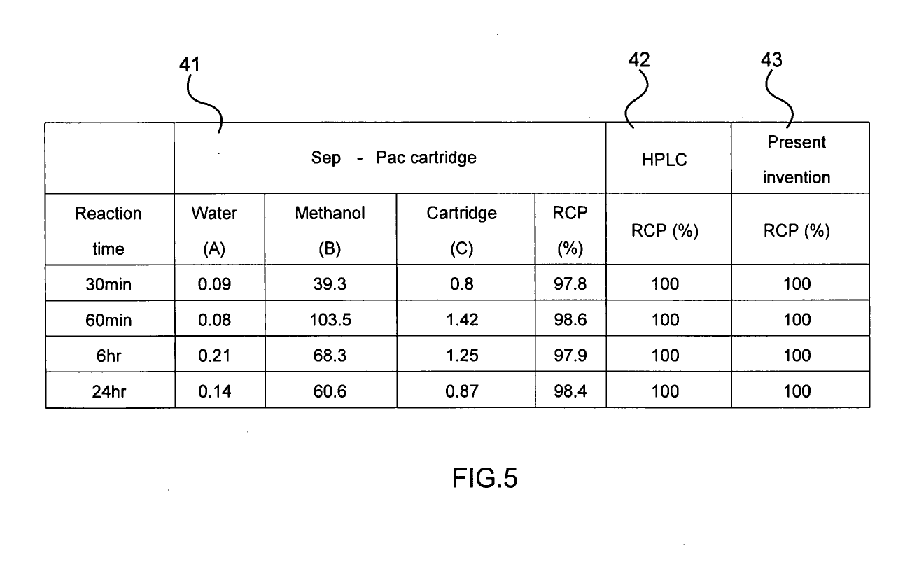

Please refer to FIG. 5, which is a view showing the analysis results of RCP by using the present invention and the prior arts. As shown in the figure, analysis results of RCP at various check points are shown in the figure by applying the present invention of an analysis method for determining RCP [43] and by using the prior arts of a Sep-Pac cartridge [41] and a High Pressure Liquid Chromatography (HPLC) system [42]. Therein, when using the Sep-Pac cartridge [41], 0.1 mL of a sample of a reconstruction of In-111-Pentetreotide and 5 mL of water for injection is injected into a Sep-Pac cartridge while a first glass vial is used to collect the first fluid overflowed. Then, another piston syringe aspirates 5 mL of methanol is followed to flow through the same cartridge using the same way mentioned just now while a second glass vial is used to collect the second fluid overflowed. In the end, 10 mL of air is injected into the cartridges, while a third glass vial is used to collect the third fluid overflowed. The radioactivity measurement is used to measure radio-activities of the first, the second and the third glass containers to obtain results A, B, C, respectively. So that an RCP for the sample of In-111-Pentetreotide is obtained by using the following formula: [B/(A+B+C)]×100%. As shown in the figure, when using the Sep-Pac cartridge [41], the RCP obtained from the formula [B/(A+B+C)]×100% at the check point of 30 minutes (min), 60 min, 6 hours (hr) and 24 hr are 97.8%, 98.6%, 97.9% and 98.4% respectively. From the point of view when using the HPLC system [42] and the present invention [43], they obtain the same results as those obtained by using the Sep-Pac cartridge [41] (with a correlation greater than 0.99), no matter concerning any result obtained at the check point of 30 min, 60 min, 6 hr or 24 hr. However, although the HPLC system [42] obtains the 100% of RCP [43] as the present invention does, the present invention obtains the analysis on the RCP [43] of the sample more easily and quickly than the HPLC system [42].

To sum up, the present invention is a rapid and convenient method for determining the RCP of In-111-Pentetreotide, where an analysis on an RCP of a sample is easily and quickly obtained.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A rapid method for determining a radiochemical purity (RCP) of In-111-Pentetreotide, comprising steps of:
(A) labeling developing spots: wherein a medium of an Instant Thin-Layer Chromatography-Silica Gel (ITLC-SG) is obtained to be labeled with a beginning spot on said ITLC-SG and an ending spot on said ITLC-SG;
(B) dropping a sample: wherein a sample of a reconstruction of a radioactive material is dropped at said beginning spot of said ITLC-SG;
(C) developing said sample: wherein said ITLC-SG is deposed in a developing tank to develop said sample and said developing tank has a buffer solution at bottom of said developing tank;
(D) Heating the ITLC-SG plate: wherein said ITLC-SG is taken out to be dried by heating after a liquid surface of said sample is developed to arrive at said ending spot of said ITLC-SG; and
(E) obtaining an analysis: wherein, after said ITLC-SG is dried by heating, said ITLC-SG is taken out to be analyzed by a radio-thin-layer chromatography scanner through an integration chromatography to obtain said analysis of an RCP of said sample.

2. The method according to claim 1,
wherein said beginning spot is located with a preferred distance of 2 centimeters (cm) to a boarder of said ITLC-SG.

3. The method according to claim 1,
wherein said ending spot is located with a preferred distance of 12 cm to a boarder of said ITLC-SG.

4. The method according to claim 1,
wherein said sample of said reconstruction of said radioactive material is made of In-111-Pentetreotide.

5. The method according to claim 1,
wherein said buffer solution of said developing tank is a solution of citrate buffer.

6. The method according to claim 1,
wherein said ITLC-SG is put into a fume hood to be dried by heating in step (D).
